(19) United States
(12) Patent Application Publication
(10) Pub. No.: US 2003/0089884 A1
(43) Pub. Date: May 15, 2003

(54) Deoxidizer and deoxidizer package

(75) Inventors: Hiroshi Nakazawa, Funabashi-Shi (JP); Tsuneo Kinjo, Chiba-Shi (JP)

Correspondence Address: SCHNADER HARRISON SEGAL & LEWIS, LLP, 1600 MARKET STREET, SUITE 3600, PHILADELPHIA, PA, 19103

(73) Assignee: MARUKATSU SANGYO CORPORATION AND KAWASAKI STEEL TECHNO-RESEARCH CORPORATION

(21) Appl. No.: 10/269,299

(22) Filed: Oct. 11, 2002

(30) Foreign Application Priority Data
Oct. 17, 2001 (JP) 2001-319109
Jul. 5, 2002 (JP) 2002-197010

(51) Int. Cl. H01K 1/56

(52) U.S. Cl. 252/181.1

(57) ABSTRACT

The present application provides a deoxidizer comprising an alkaline compound, silicon, a porous substance, water and at least one organic acid selected from the group consisting of ascorbic acid, isomers thereof and phenol derivatives where pH of an extract when 1 g of the deoxidizer is extracted with 10 ml of water is 8 or lower. The deoxidizer does not generate hydrogen gas and achieves an excellent deoxidizing ability even at from weakly alkaline to acidic regions. When a suppressant for generation of hydrogen is further added to the deoxidizer, generation of hydrogen is suppressed even when the pH is 10 or lower and an excellent deoxidizing ability can be maintained as well. Those deoxidizers do not interfere with the food test using a metal detector.

### BACKGROUND OF THE INVENTION

1. Field of the Invention

The present invention relates to a deoxidizer and a deoxidizer package in which the deoxidizer is packed.

2. Description of the Related Art

As one of the art for preservation of foods, there has been established an art where oxygen remaining in a container in which food is tightly closed is trapped by means of chemical reaction, physical adsorption or the like to carry out prevention of generation of fungi and bacteria, prevention of oxidation of food, prevention of discoloration, prevention of denaturation, etc. With regard to the deoxidizer as such, a deoxidizer of metal type which reacts with oxygen so that oxygen is chemically fixed has been well known. A deoxidizer of an iron type where oxidation of iron metal is utilized has been most diffusing. Usually, a deoxidizer is packed with a gas-permeable material and the resulting deoxidizer package is placed in a tightly closed container together with food.

With regard to the deoxidizer of a metal type, those using iron, copper, tin, zinc, nickel, etc. are used (Japanese Patent Laid-Open Nos. 119488/1977 and 119489/1977) and that using magnesium (Japanese Patent Laid-Open No. 122688/1979) have been known for example. Especially with regard to a deoxidizer of an iron type, there are many proposals. For example, that where oxygen absorption rate is increased is disclosed in Japanese Patent Laid-Open No. 79038/1980. In Japanese Patent Laid-Open Nos. 233768/1988 and 237374/1993, that where a decrease of gas volume in a container is supplemented by generation of carbon dioxide gas to prevent the deformation of the container and that which relates to supply of water to iron powder are proposed, respectively.

However, since a deoxidizer of a metal type is detected by a metal detector used for examination of foreign matters contained in the food container, there is a problem that it is unable to be distinguished the deoxidizer from metallic foreign matters. Therefore, there are some cases where a deoxidizer of a metal type cannot be used in food manufacturers. In order to solve such a problem, it is possible to use a deoxidizer of a silicon type or a deoxidizer of an organic type as a deoxidizer which is not detected by a metal detector.

With regard to a deoxidizer of a silicon type, there have been proposed the compositions to which silicon, alkaline substance such as potassium hydroxide, support such as activated carbon and also water are added (specification of Japanese Patent No. 2,836,126).

However, silicon reacts with an aqueous solution of alkali hydroxide whereupon metasilicic acid ion is produced and hydrogen gas is generated as well.

Si+2OH⁻+H₂O→SiO₃²⁻+2H₂

All of the conventional deoxidizers of a silicon type are used under a strongly alkaline condition where alkali in the same amount as silicon is mixed and generation of a large amount of hydrogen has been unable to be avoided. When hydrogen gas is generated in a large amount, the container with deoxidizer wherein food is tightly closed is swollen or broken during storage and is no longer used. According to the experiment by the present inventors, it has been found that deoxidizing ability per unit weight is low in the conventional deoxidizers of a silicon type and that the deoxidizing ability is saturated with a lapse of time. Therefore, it is difficult to make the residual oxygen concentration substantially nil and the conventional deoxidizers of a silicon type are not good for practical use.

With regard to a deoxidizer of an organic type, a composition where activated carbon and water are added to ascorbic acid or alkaline salt thereof is disclosed in Japanese Patent Laid-Open No. 136845/1976 for example. In Japanese Patent Laid-Open No. 269376/1993, there is disclosed a composition where metal compound such as alkaline metal carbonate or ferrous sulfate, inorganic filler such as zeolite and water are added to ascorbic acid or a salt thereof. In Japanese Patent Laid-Open No. 235189/1998, there is disclosed a composition where pH adjusting agent such as sodium carbonate or calcium hydroxide, reactivity enhancer such as activated carbon and crystalline cellulose such as Avicel are added to gallic acid.

However, a deoxidizer of an organic type has slower deoxidizing rate as compared with a deoxidizer of an iron type and, in order to make the residual oxygen amount substantially nil, long time is needed. Alternatively, when the desired ability is to be achieved, it is necessary to increase the amount of the deoxidizer.

The present invention provides a deoxidizer where silicon and organic acid having strong reducing force are main components, generation of hydrogen is suppressed, deoxidizing rate is quicker than the conventional deoxidizers of a silicon type and of an organic type and deoxidization is possible within a short time. Another object is to provide a deoxidizer package where the deoxidizer is packed.

### SUMMARY OF THE INVENTION

Thus, the present invention relates to a deoxidizer comprising an alkaline compound, silicon, a porous substance, water and at least one organic acid selected from the group consisting of ascorbic acid, isomers thereof and phenol derivatives where pH of an extract when 1 g of the deoxidizer is extracted with 10 ml of water is 8 or lower. It also provides an invention for a deoxidizer comprising an alkaline compound, silicon, a suppressant for the generation of hydrogen, a porous substance, water and at least one organic acid selected from the group consisting of ascorbic acid, isomers thereof and phenol derivatives where pH of an extract when 1 g of the deoxidizer is extracted with 10 ml of water is 10 or lower. Especially in the case of the latter deoxidizer with the suppressant for the generation of hydrogen, it is preferred that the suppressant for the generation of hydrogen is at least one substance selected from the group consisting of gelatin, collagen and glue.

In any one of the above-mentioned deoxidizers, it is preferred that a mixing ratio of the silicon to the organic acid is that the organic acid is 0.3 to 5 part(s) by weight to 1 part by weight of the silicon. It is more preferred that the silicon is silicon powder where an average particle size is 75 μm or smaller (passing through a sieve of 200 mesh).

Further, in anyone of the above-mentioned deoxidizers, it is preferred that the organic acid is at least one substance selected from the group consisting of L-ascorbic acid, erythorbic acid, polyhydric phenol derivatives and gallic acid.

Furthermore, in any one of the above-mentioned deoxidizers, it is preferred that the porous substance is at least one substance selected from the group consisting of activated carbon, diatomaceous earth, bone black and zeolite.

Moreover, in anyone of the above-mentioned deoxidizers, it is preferred that the deoxidizer further contains a moisture retainer.

The present application also provides an invention for a deoxidizer package where any one of the above-mentioned deoxidizers is contained in a gas-permeable packing material.

### DETAILED DESCRIPTION OF PREFERRED EMBODIMENT

The present inventors have started in studying for suppression of hydrogen generated from a deoxidizer of a silicon type. In that reaction system, there are predicted a reaction where silicon reacts with an alkaline solution to generate metasilicic acid ion and hydrogen and a reaction where silicon reacts with oxygen to generate silicon oxide and fix the oxygen. The present inventors also investigated that, in those two competitive reactions, how to make the latter reaction advantageous. However, during initial phases of the investigation, generation of hydrogen was unable to be suppressed under an alkaline region even when the pH region is changed. In addition, deoxidizing ability was insufficient at from neutral to acidic regions. On the other hand, in most of the conventional deoxidizers of an organic type where L-ascorbic acid or the like is used as a main component, most of them are used under a strongly alkaline condition as well. We have tried to use a deoxidizer of an organic type together with a deoxidizer of a silicon type. Even by the joint use as such, generation of hydrogen was unable to be suppressed under a strongly alkaline region. To our surprise however, it was found that generation of hydrogen was able to be suppressed under a weakly alkaline region of pH 8 or lower to neutral and acidic regions and that a sufficient deoxidizing ability was achieved as well. More surprisingly, it was found as a result of further study of such deoxidizers of a joint-use type that, when a derived protein such as gelatin co-exits, generation of hydrogen was suppressed even under an alkaline region provided that the pH is 10 or lower whereupon a deoxidizer having a high deoxidizing ability was prepared. On the basis of the above finding, the present invention has been accomplished.

Thus, the present invention relates to a deoxidizer comprising an alkaline compound, silicon, a porous substance, water and at least one organic acid selected from the group consisting of ascorbic acid, isomers thereof and phenol derivatives where pH of an extract when 1 g of the deoxidizer is extracted with 10 ml of water is 8 or lower. It also provides an invention for a deoxidizer comprising an alkaline compound, silicon, a suppressant for the generation of hydrogen, a porous substance, water and at least one organic acid selected from the group consisting of ascorbic acid, isomers thereof and phenol derivatives where pH of an extract when 1 g of the deoxidizer is extracted with 10 ml of water is 10 or lower.

In the deoxidizer of the present invention, silicon is used as one of the main materials. Although there is no particular limitation for the shape of the silicon used, it is preferred to be powdery in view of improving the deoxidizing ability. An average particle size of the powder is preferably 75 μm or smaller (passing through a sieve of 200 mesh) or, more preferably, 50 μm or smaller. Particularly preferably, the average particle size is 10 μm or smaller. Such silicon can be prepared, for example, by classifying into a predetermined particle size by such a means that silicon blocks, silicon wafer (silicon in plates), silicon powder, etc. are ground by a grinder followed by sieving. It is also possible to use off-grade goods, waste after cutting, waste after shaving, etc. which are produced in silicon wafer factories, semiconductor factories, etc.

In the deoxidizer of the present invention, at least one organic acid selected from the group consisting of ascorbic acid, isomers thereof and phenol derivatives as another main material. Examples of such an organic acid are water-soluble vitamins such as ascorbic acid and erythorbic acid which is an isomer of ascorbic acid while, with regard to the phenol derivatives, examples are monohydric phenols such as 3,5-xylenol, dibutylhydroxytoluene and butylhydroxyanisole, dihydric phenols such as catechol, resorcinol and hydroquinone and trihydric phenols such as pyrogallol, oxyhydroquinone, phloroglucinol and gallic acid. Preferred one is at least one substance selected from the group consisting of L-ascorbic acid, erythorbic acid and polyhydric phenol derivatives. Among the polyphenol derivatives, gallic acid is suitable.

Besides the above-mentioned organic acids, it is also possible to use carboxylic acids such as benzoic acid, salicylic acid, oxalic acid, glutamic acid, adipic acid, tartaric acid and citric acid. Organic acids having stronger reducing ability are preferred.

With regard to the silicon and the organic acid used in the present invention, it is preferred to use in a ratio of 0.1˜10 part(s) by weight of the organic acid to 1 part by weight of the silicon. The ratio is more preferably 0.3˜5 part(s) by weight and, still more preferably, 0.3˜2 part(s) by weight.

The deoxidizer of the present invention contains an alkaline compound. The alkaline compound forms a salt as a result of reaction with the above-mentioned organic acid. There is no particular limitation for such an alkaline compound and its examples are hydroxides, carbonates and bicarbonates of alkaline metal and alkaline earth metal. Preferred examples are sodium hydroxide, potassium hydroxide, calcium hydroxide, sodium carbonate, potassium carbonate, calcium carbonate, sodium bicarbonate and potassium bicarbonate. On the other hand, as will be mentioned later, the present invention also stipulates the pH region of an extract when 1 g of the resulting deoxidizer is extracted with 10 ml of water. The alkaline compound of the present invention may be also regarded as a substantial pH adjusting agent for making the predetermined pH region of the present invention satisfactory. The deoxidizer of the present invention may also contain acids and alkalis which are other than those stipulated by the claims and, usually, the predetermined pH region is adjusted by the said alkaline substance taking the co-existence of such other substances into consideration as a whole. Accordingly, its amount is decided by the desired pH value. Needless to say, the organic acid and the alkaline substance of the present invention form a salt in the system as mentioned above and, therefore, it is also possible to use a salt of the said organic acid in place of the organic acid and/or alkaline compound of the present invention.

The present invention stipulates the pH region of an extract when 1 g of the resulting deoxidizer is extracted with 10 ml of water. The components constituting the deoxidizer of the present invention are within a range from water-insoluble ones to those which are hardly soluble, soluble or easily soluble in water. Therefore, the pH value is usually determined by such a manner that a certain amount of the deoxidizer is placed in a container such as a beaker, water in the stipulated ratio is added thereto and pH of an aqueous solution extracted with water at around room temperature (15˜30° C.) is measured by a pH-meter or the like. It is preferred that, at that time, the deoxidizer is ground or is stirred upon extraction so as to improve the extracting efficiency. The pH may be measured after separating the extract from insoluble matters by, for example, means of filtration or may be measured in a state of a suspension per se. Usually, the pH value is substantially determined by the amounts of the above-mentioned organic acid and alkaline compound in many cases. In addition, since many salts are soluble in water, extraction with heating is ordinarily not necessary.

Stipulation of the pH region of the present invention varies depending upon the fact whether a suppressant for hydrogen generation which will be mentioned later is present or absent.

Thus, when the deoxidizer of the present invention does not contain a suppressant for hydrogen generation, the said pH is to be 8 or lower. Preferably, it is pH 3˜7.5 and, more preferably, it is pH 4.5˜7. When it is pH 8 or lower, generation of hydrogen is well suppressed and, moreover, the desired effect of the deoxidizing ability is achieved. Although silicon is gradually corroded by aqua regia and is easily corroded by a mixed acid of hydrofluoric acid and nitric acid, it has no reactivity with common acids and is stable. Accordingly, all of the conventional silicon-containing deoxidizers achieve their action when used under a strongly alkaline condition. There has been no example as in the present invention where they are used under a weakly alkaline condition and, to say nothing of, under an acidic condition.

On the other hand, when a suppressant for hydrogen generation is contained, the said pH is 10 or lower whereby the applicable pH region become broad. Preferably, the pH is 3˜10 and, more preferably, it is 4.5˜9. When the said pH is 10 or lower, the desired effect is achieved while, when it is higher than 10, generation of hydrogen becomes vigorous whereby it is not possible to suppress the generation of hydrogen. Accordingly, for an object that hydrogen is not substantially generated, pH is to be made 10 or lower. As to a yardstick therefor, there may be exemplified a case where 4 parts by weight or more of L-ascorbic acid are used to 1 part by weight of sodium hydroxide. The said ratio is preferably 4˜20 parts by weight and, more preferably, it is 4˜12 parts by weight.

The organic acid and the alkaline compound of the present invention not only prevent the generation of hydrogen but also are able to effectively enhance the deoxidizing ability due to synergism with silicon.

When the pH is 10 or lower in the present invention, the co-existence of a suppressant for hydrogen generation is necessary as mentioned above. A suppressant for hydrogen generation is a substance having an action of potentiating the hydrogen overvoltage. For example, derived proteins (e.g., gelatin, collagen, glue, plakalbumin, metaprotein, coagulated protein, proteose, peptide and peptone), colloidal substances (e.g., gum substance, casein, kinin, agar, dextrin and tragacanth gum) and crystalline substances having a high molecular weight (e.g., alkaloids, glucoxide and dye) are effective. Derived protein is preferred and gelatin and collagen are particularly preferred. Amount of the suppressant for hydrogen generation used to 1 part by weight of silicon is preferably 0.01˜0.5 part by weight. Particularly preferably, 0.05˜0.2 part by weight is used.

The deoxidizer of the present invention contains water. Water is necessary in such a respect that it moistens a porous substance having a large surface area such as activated carbon and zeolite whereby the deoxidizer is well contacted to the air so as to efficiently absorb much oxygen into the liquid. Water also functions as a reaction medium for the reaction with a substance which incorporates oxygen such as silicon, organic acid and salt thereof. The amount of water used is 0.05˜0.3 part by weight to 1 part by weight of the deoxidizer. It is preferably 0.08˜0.25 part by weight. Such an amount of water is within a degree of mere moisture in all the deoxidizer and the appearance of the deoxidizer is mostly solid.

The deoxidizer of the present invention contains a porous substance as an essential component. The porous substance has an action of trapping the oxygen remaining in the tightly closed container for food. It is an additive having a meritorious effect of enhancing the oxygen-absorbing rate and/or oxygen-absorbing amount of silicon and the organic acid. Examples of the porous substance are that of a plant type such as activated carbon, charcoal and bamboo charcoal, that of an animal type such as bone black and that of a mineral type such as zeolite and diatomaceous earth. Preferred ones are activated carbon, diatomaceous earth, bone black and zeolite. There is no particular limitation for the shape, average particle size, specific surface area, etc. of the porous substance so far as they do not affect the mixing with silicon powder and the manufacture of the product although it is preferred to be powder which is easy for mixing where an average particle size is 2 mm or smaller.

Amount of the porous substance used is preferably 0.5˜5 part(s) by weight to 1 part by weight of the total amount of silicon and the organic acid. It is particularly preferred to use 0.6˜3 part(s) by weight.

Further, the deoxidizer of the present invention may be appropriately compounded with a moisture-retaining agent for ensuring the moisture necessary for promoting the oxygen absorption of the deoxidizer and also with a filler such as talc or “Aerosil” for improving the fluidity.

A moisture-retaining agent is a substance having a property of absorbing and retaining the moisture. Its examples are minerals such as vermiculite, pearlite, bentonite, kaolin, clay, acid clay, active clay, diatomaceous earth, talc, silica gel and zeolite, as well as paper, cloth and high-molecular materials. Some of them also act as a porous substance which is an essential component of the present invention such as zeolite and diatomaceous earth. Preferred ones are a substance which is light and has a water-retaining property such as vermiculite and pearlite and a substance which has a high water-retaining property such as talc, acid clay and active clay.

The deoxidizer of the present invention is preferably prepared in such a manner that a water-soluble substance such as organic acid or a salt thereof and a suppressant for hydrogen generation are firstly added to water to prepare an aqueous solution and then a water-insoluble substance such as silicon, a porous substance, a moisture-retaining agent and a filler are added. With regard to the suppressant for hydrogen generation and the organic acid, it is not necessary that all amounts of them are blended with the aqueous solution but a part of them may be blended with an insoluble substance such as silicon, a porous substance, a moisture-retaining agent and a filler.

The deoxidizer of the present invention is packed, for example, in a packing paper constituted from a gas-permeable material in an appropriate amount to give a deoxidizer package. With regard to the gas-permeable material, the packing method, etc., common ones may be adopted. For example, the deoxidizer is received in a packing paper comprising a gas-permeable laminated film made of paper and polyethylene and sealed by a heat sealer to prepare a deoxidizer package.

The deoxidizer package is contained in a gas-unpermeable food container together with food, tightly closed and is subjected to storage or transportation.

In the present specification, the case where the deoxidizer is for food is chiefly illustrated although it goes without saying that the deoxidizer can be also applied to other cases than food such as to metal products, non-metal products, raw materials, etc. where inconvenience caused by oxidation ha been worried about. To be more specific, the deoxidizer is applicable to pharmaceuticals, electronic materials, medical instruments, etc.

### EXAMPLES

### Examples 1 to 11

There were used gelatin and collagen as suppressant for hydrogen generation, L-ascorbic acid and gallic acid as organic acids, sodium erythorbate as an organic salt, sodium hydroxide and calcium hydroxide as alkaline compounds for adjustment of pH and water. They were used in a ratio as shown in Table 1 (part(s) by weight) to prepare aqueous solutions 1˜12 having pH values as shown in Table 1. Each of the said aqueous solutions 1˜9 was blened with silicon powder and activated carbon as a porous substance, talc and zeolite in the part(s) by weight as shown in Table 2 to prepare a deoxidizer. Incidentally, pH of an aqueous solution extracted with 10 ml of water per gram of the deoxidizer was measured by a pH meter and was found to be nearly identical with that in Table 1.

Five grams of said deoxidizer was charged in a gas-permeable packing material to prepare a deoxidizer package. This was placed in a barrier bag of 20 cm×30 cm, the bag was tightly sealed using a sealer (“Cute Sealer V-300” manufactured by Fuji Impulse K. K.) and 500 ml of air were injected thereinto using a syringe. After predetermined time, the air in the barrier bag was collected by a syringe and oxygen concentration was determined by an oxygen concentration meter (“LC-750F” manufactured by Toray Engineering K. K.). Incidentally, the initial oxygen concentration in the air sealed into the barrier bag was 20.6% by volume in all cases.

Separately, 25 g of a deoxidizer having a composition as shown in Table 2 were charged in a gas-permeable packing material to prepare a deoxidizer package. This was charged into a barrier bag of 20 cm×30 cm, the barrier bag was tightly sealed using a sealer (“Cute Sealer V-300” manufactured by Fuji Impulse K. K.) and all air in the barrier bag was taken out by a syringe to give a deaerated state. Generation of gas in the barrier bag after elapse of predetermined time was observed.

In any of the cases, an adhesive tape was applied to the part wherefrom a needle for ayringe is to be inserted. An operation of injection of the air or drawing-out of the gas in the barrier bag was carried out by penetrating through the said rubber tape so as to maintain the air-tightness of the barrier bag after removal of the needle for syringe.

The result is shown in Table 2. The oxygen concentration reached zero within a day or two. That is a very quick absorbing rate which is by no means inferior to commercially available deoxidizers of an iron type. In the meanwhile, any of the barrier bags in which 25 g of the deoxidizer were kept in a deaerated state showed no generation of gas causing a problem in reality.

When the deoxidizers of the Examples 1 to 11 were tested by a metal detector, none of them showed the reaction.

### Comparative Examples 1 to 3

Each of the aqueous solutions 10 to 12 as shown in Table 1 was blended with silicon powder and activated carbon as a porous substance in a composition (part(s) by weight) as shown in Table 3 to prepare a deoxidizer. Incidentally, pH of an aqueous solution extracted with 10 ml of water per gram of the deoxidizer at room temperature was measured by a pH meter and was found to be nearly identical with that in Table 1.

Twenty-five grams of said deoxidizer was charged in a gas-permeable packing material to prepare a deoxidizer package. This was charged into a barrier bag of 20 cm×30 cm, the barrier bag was tightly sealed using a sealer (“Cute Sealer V-300” manufactured by Fuji Impulse K. K.) and all air in the barrier bag was taken out by a syringe to result in a deaerated state. Generation of gas in the barrier bag after elapse of predetermined time was measured.

In any of the cases, an adhesive tape was applied to the part wherefrom a needle for syringe is to be inserted. An operation of injection of the air or drawing-out of the gas in the barrier bag was carried out by penetrating through the said rubber tape so as to keep the air-tightness of the barrier bag after removal of the needle for syringe.

In Comparative Example 1 in which a suppressant for hydrogen generation (gelatin) was not blended, gas was generated even when there was blended an aqueous solution 10 where pH of an aqueous extract as stipulated by the present invention was pH 8.5. In addition, as noted in Comparative Examples 2 and 3, vigorous generation of gas was noted when pH of the blended aqueous solution was higher than 10 even when gelatin was blended as a suppressant for hydrogen generation.

As noted in Comparative Examples 1 to 3, the deoxidizers wherefrom gas was generated even when kept in a deaerated state where no air was contacted thereto were unable to be practically used because of swelling of a barrier bag during storage and transportation of the deoxidizer.

### Example 12

The aqueous solution 9 as shown in Table 1 was blended with silicon powder and also activated carbon and zeolite as porous substances in the part(s) by weight as shown in Table 4 to prepare a deoxidizer. Incidentally, pH of an aqueous solution extracted with 10 ml of water per gram of the deoxidizer at room temperature was measured by a pH meter and was found to be nearly identical with that in Table 1.

The said deoxidizer (3.5 g) was charged in a gas-permeable packing material to prepare a deoxidizer package. This was placed in a barrier bag of 25 cm×35 cm, the bag was tightly sealed using a sealer (“Cute Sealer V-300” manufactured by Fuji Impulse K. K.) and 1,500 ml of air were injected thereinto using a syringe. After one week, the air in the barrier bag was collected by a syringe and oxygen concentration was determined by an oxygen concentration meter (“LC-750F” manufactured by Toray Engineering K. K.). Amount of oxygen consumed was calculated from the above value by calculation whereupon amount of absorbed oxygen per gram of the deoxidizer was calculated. Incidentally, the initial oxygen concentration in the air sealed into the barrier bag was 20.6% by volume.

The result is shown in Table 4. Amount of the absorbed oxygen per gram of the deoxidizer was as so much as 60 ml/g.

### Comparative Example 4

The aqueous solution 9 as shown in Table 1 was blended with activated carbon and zeolite as porous substances in the part(s) by weight as shown in Table 4 to prepare a deoxidizer. In Comparative Example 4, no silicon powder was used and, in place of silicon powder, there were used activated carbon and zeolite where their mixing ratio was as same as that in Example 12. Incidentally, pH of an aqueous solution extracted with 10 ml of water per gram of the deoxidizer at room temperature was measured by a pH meter and was found to be nearly identical with that in Table 1.

The said deoxidizer (3.5 g) was charged in a gas-permeable packing material to prepare a deoxidizer package. This was placed in a barrier bag of 25 cm×35 cm, the bag was tightly sealed using a sealer (“Cute Sealer V-300” manufactured by Fuji Impulse K. K.) and 1,500 ml of air were injected thereinto using a syringe. After one week, the air in the barrier bag was collected by a syringe and oxygen concentration was determined by an oxygen concentration meter (“LC-750F” manufactured by Toray Engineering K. K.). Amount of oxygen consumed was calculated from the above value by calculation whereupon amount of absorbed oxygen per gram of the deoxidizer was calculated. Incidentally, the initial oxygen concentration in the air sealed into the barrier bag was 20.6% by volume.

The result is shown in Table 4. Amount of the absorbed oxygen per gram of the deoxidizer was as so much as 35 ml/g.

Although silicon is stable in an acidic condition, its joint use was found to result in a significant improvement in a deoxidizing ability as shown in Example 12.

Since the deoxidizer according to the present invention does not use metal such as iron powder, it is not detected by a metal detector whereby a test of food whether metal is mixed therein can be carried out. Generation of gas such as hydrogen can be suppressed and, in addition, deoxidization is possible within a day or two. There is also available a high deoxidizing ability where amount of absorption of oxygen per unit weight is excellent.

TABLE 1

| | Aqueous Solution Nos. | | | | | | | | | | | |
|---|---|---|---|---|---|---|---|---|---|---|---|---|
| Components (parts by wt) | 1 | 2 | 3 | 4 | 5 | 6 | 7 | 8 | 9 | 10 | 11 | 12 |
| Water | 17.6 | 16.7 | 22.3 | 22.6 | 19.1 | 21.9 | 21.9 | 18.9 | 12.0 | 21.6 | 25.5 | 21.9 |
| L-Ascorbic acid | 12.3 | 12.5 | 12.1 | 12.1 | 0 | 12.1 | 12.1 | 8.8 | 13.5 | 9.5 | 6.3 | 12.1 |
| Na Erythorbate | 11.0 | 11.1 | 0 | 0 | 0 | 0 | 0 | 8.8 | 12.0 | 0 | 0 | 0 |
| Gallic acid | 0 | 0 | 0 | 0 | 10.0 | 0 | 0 | 0 | 0 | 0 | 0 | 0 |
| Gelatin | 2.0 | 2.0 | 2.5 | 2.5 | 2.1 | 2.9 | 2.4 | 0 | 0 | 0 | 2.8 | 2.5 |
| Collagen | 0 | 0 | 0 | 0 | 0 | 0 | 0 | 2.1 | 0 | 0 | 0 | 0 |
| NaOH | 2.3 | 2.2 | 2.5 | 2.0 | 2.1 | 2.4 | 2.9 | 2.5 | 2.4 | 2.3 | 2.8 | 2.9 |
| Ca(OH)₂ | 0 | 0 | 0 | 0.1 | 0 | 0 | 0 | 0 | 0 | 0 | 0 | 3.0 |
| Total | 45.2 | 44.5 | 39.4 | 39.4 | 33.3 | 39.4 | 39.4 | 41.1 | 39.9 | 33.4 | 37.4 | 42.4 |
| pH | 4.8 | 4.8 | 5.3 | 5.4 | 6.1 | 6.6 | 8.5 | 9.1 | 4.7 | 8.5 | 10.7 | 11.0 |

TABLE 2

| | | | | | | | State in Barrier Bag | | |
|---|---|---|---|---|---|---|---|---|---|
| | Blending Composition of Deoxidizer (wt parts) | | | | | | | | Amt of |
| | | | | Porous Substances | | | | Oxygen | Generated |
| | Aqueous | | Silicon | Activated | | | Days | Concn | Gas |
| | Solution | | Powder | carbon | Talc | Zeolite | Elapsed | (vol. %) | (ml/5 g) |
| Ex. 1 | No. 1 | 45.2 | 21.9 | 21.9 | 0 | 11.0 | 1.0 | 0 | 0 |
| Ex. 2 | No. 2 | 44.5 | 22.2 | 21.9 | 0 | 8.3 | 1.0 | 0 | 0 |
| Ex. 3 | No. 3 | 39.4 | 30.3 | 25.0 | 0 | 0 | 1.5 | 0 | 0 |
| Ex. 4 | No. 4 | 39.4 | 24.2 | 30.3 | 9.1 | 0 | 1.0 | 0 | 0 |
| Ex. 5 | No. 5 | 33.3 | 33.3 | 27.3 | 0 | 0 | 2.0 | 0 | 0 |
| Ex. 6 | No. 6 | 39.4 | 30.3 | 33.3 | 0 | 0 | 1.5 | 0 | 0 |
| Ex. 7 | No. 7 | 39.4 | 24.2 | 30.3 | 0 | 0 | 1.5 | 0 | 0 |
| Ex. 8 | No. 7 | 39.4 | 24.2 | 36.4 | 9.1 | 0 | 1.5 | 0 | 0 |
| Ex. 9 | No. 7 | 39.4 | 24.2 | 27.3 | 0 | 12.1 | 1.0 | 0 | 0 |
| Ex. 10 | No. 8 | 41.1 | 23.5 | 26.5 | 0 | 8.8 | 2.0 | 0 | 0 |
| Ex. 11 | No. 9 | 39.9 | 24.0 | 27.0 | 0 | 9.0 | 1.0 | 0 | 0 |

TABLE 3

| | Blending Composition of Deoxidizer (wt parts) | | | | | | | |
|---|---|---|---|---|---|---|---|---|
| | | | | Porous Substances | | | Amt of Gas Generated in Barrier Bag | |
| Comp | Aqueous | | Silicon | Activated | | | Days | Amt of Generated Gas |
| Ex | Solution | | Powder | carbon | Talc | Zeolite | Elapsed | (ml/5 g) |
| 1 | No. 10 | 33.4 | 33.3 | 33.3 | 0 | 0 | 4 | 50 |
| 2 | No. 11 | 37.4 | 31.3 | 31.3 | 0 | 0 | 4 | 88 |
| 3 | No. 12 | 42.4 | 24.3 | 33.3 | 0 | 0 | 4 | 550 |

TABLE 4

| | Blending Composition of Deoxidizer (wt parts) | | | | | | |
|---|---|---|---|---|---|---|---|
| | | | | Porous Substances | | | Oxygen Absorbing Ability |
| | Aqueous | | Silicon | Activated | | | Amt of Oxygen |
| | Solution | | Powder | carbon | Talc | Zeolite | Absorbed (ml/g) |
| Ex. 12 | No. 9 | 39.9 | 24 | 27 | 0 | 9 | 60 |
| Comp. Ex. 4 | No. 9 | 39.9 | 0 | 45 | 0 | 15 | 35 |

What is claimed is:

1. A deoxidizer comprising an alkaline compound, silicon, porous substance, water and at least one organic acid selected from the group consisting of ascorbic acid, isomers thereof and phenol derivatives where pH of an extract when 1 g of the deoxidizer is extracted with 10 ml of water is 8 or lower.

2. The deoxidizer according to claim 1, wherein a mixing ratio of the silicon and the organic acid is from 0.3 to 5 part (s) by weight of the organic acid to 1 part by weight of the silicon.

3. The deoxidizer according to claim 1, wherein the organic acid is at least one substance selected from the group consisting of L-ascorbic acid, erythorbic acid, polyhydric phenol derivatives and gallic acid.

4. The deoxidizer according to claim 1, wherein the porous substance is at least one substance selected from the group consisting of activated carbon, diatomaceous earth, bone black and zeolite.

5. The deoxidizer according to claim 1, wherein the silicon is silicon powder having an average particle size of 75 μm or smaller.

6. The deoxidizer according to claim 1, wherein the deoxidizer further contains a moisture-retaining agent.

7. A doxidizer package where the deoxidizer mentioned in any one of claims 1 to 6 is contained in a gas-permeable packing material.

8. A deoxidizer comprising an alkaline compound, silicon, a suppressant for generation of hydrogen, a porous substance, water and at least one organic acid selected from the group consisting of ascorbic acid, isomers thereof and phenol derivatives where pH of an extract when 1 g of the deoxidizer is extracted with 10 ml of water is 10 or lower.

9. The deoxidizer according to claim 8, wherein a mixing ratio of the silicon and the organic acid is from 0.3 to 5 part(s) by weight of the organic acid to 1 part by weight of the silicon.

10. The deoxidizer according to claim 8, wherein the organic acid is at least one substance selected from the group consisting of L-ascorbic acid, erythorbic acid, polyhydric phenol derivatives and gallic acid.

11. The deoxidizer according to claim 8, wherein the suppressant for generation of hydrogen is at least one substance selected from the group consisting of gelatin, collagen and glue.

12. The deoxidizer according to claim 8, wherein the porous substance is at least one substance selected from the group consisting of activated carbon, diatomaceous earth, bone black and zeolite.

13. The deoxidizer according to claim 8, wherein the silicon is silicon powder having an average particle size of 75 μm or smaller.

14. The deoxidizer according to claim 8, wherein the deoxidizer further contains a moisture-retaining agent.

15. A deoxidizer package where the deoxidizer mentioned in any one of claims 8 to 14 is contained in a gas-permeable packing material.
